(19) United States
(12) Patent Application Publication
(10) Pub. No.: US 2018/0133524 A1
(43) Pub. Date: May 17, 2018

(54) MASK FOR PREVENTING INHALATION OF POLLUTANTS

(71) Applicant: CREVALUES CO., LTD, Namyangju-si, Gyeonggi-do (KR)

(72) Inventor: Dae Soo JANG, Namyangju-si (KR)

(73) Assignee: CREVALUES CO., LTD, Namyangju-si, Gyeonggi-do (KR)

(21) Appl. No.: 15/564,304

(22) PCT Filed: Mar. 30, 2016
(86) PCT No.: PCT/KR2016/003226

§ 371 Date: Oct. 4, 2017

(30) Foreign Application Priority Data
Apr. 14, 2015 (KR) 10-2015-0052275

(51) Int. Cl. A62B 18/02

(52) U.S. Cl. CPC A62B 18/02

(57) ABSTRACT

A mask for preventing inhalation of pollutants according to the present invention includes a mask main body which covers a user's face and forms a breathing space, which is a space formed between an inner surface thereof and the user's face, an air pocket formed on one side of the breathing space and filled with air passing through the mask main body from an outside of the mask, and an air guide member operated to supply the air inside the air pocket to the breathing space during inhalation and discharge air inside the breathing space to the outside during exhalation.

### TECHNICAL FIELD

The present invention relates to a mask for preventing inhalation of pollutants, and more specifically, to a mask for preventing inhalation of pollutants capable of preventing inhalation of external pollutants and minimizing breathing discomfort due to the mask being worn while breathing by additionally including an air pocket filled with external air and formed between a mask main body, which has an edge pressed against a user's face, and the user's face or at an outer side of the mask main body to supply the external air to the user during inhalation and to discharge air generated during exhalation to an outside of the mask.

### BACKGROUND ART

Generally, a mask prevents inhalation of pollutants harmful to the human body, such as dust, yellow dust, fine dust, and the like, contained in the air into respiratory organs, and various structures thereof according to an environment and a purpose of use of the mask have been known.

A mask according to a conventional technology has a structure in which a user's face is covered by using a pollutant filtering cloth, and the mask has disadvantages in that breathing is inconvenient because the filtering cloth is pressed against a respiratory organ such as the mouth or nose of the user and it is easy for pollutants to pass therethrough. To solve such a problem, although a mask having a structure in which an inner surface including a filtering non-woven fabric is fused to a cap shaped outer surface formed of a synthetic resin material has been developed, since the structure of the mask is formed such that a user inhaled air introduced into the inner surface through a plurality of through holes formed in the outer surface and discharged exhaled air in the mask, intake air and discharged air are mixed, a concentration of oxygen inside the mask decreases, exhaled air is not smoothly discharged to the outside of the mask, and thus there is a problem in that it is not easy to keep breathing.

Accordingly, to solve such a conventional problem, although a dust mask having a structure in which a dust filter is installed around a front or side surface of the mask such that a user inhales air through the dust filter has been developed, as disclosed in [Disclosure 1], since the mask has a complex structure, is expensive, and has a shape similar to a gas mask, in a case in which a general user wears the mask for enjoying outdoor activities or sports, too many activities are hindered even though the mask might be used in industrial fields, and thus there is a problem in that practicality is reduced.

[Literature 1] Korean Laid-open Utility Patent No. 2009-0010452 (disclosed Oct. 14, 2009)

### DISCLOSURE

### Technical Problem

The present invention is directed to providing a mask for preventing inhalation of pollutants capable of preventing inhalation of an external pollutant by including a simple structure in which an additional air pocket filled with external air and formed between a mask main body, which has an edge pressed against a user's face, and the user's face or at an outer side of the mask main body to supply the external air to the user during inhalation and to discharge air generated during exhalation to an outside of the mask and capable of reducing breathing discomfort due to the mask being worn while breathing by minimizing mixing of intake air and discharge air inside the mask.

### Technical Solution

One aspect of the present invention provides a mask for preventing inhalation of pollutants including a mask main body which covers a user's face and forms a breathing space which is a space formed between an inner surface thereof and the user's face, an air pocket formed on one side of the breathing space and filled with air passing through the mask main body from an outside of the mask, and an air guide member operated to supply the air inside the air pocket to the breathing space during inhalation and discharge air inside the breathing space to the outside during exhalation.

The air guide member may include an inhalation valve installed on one side of the air pocket to guide the air inside the air pocket to the breathing space or block the air, and a discharge valve installed on one side of the mask main body to guide the air inside the breathing space to the outside or block the air, wherein the inhalation valve may be open during inhalation and closed during exhalation, and the discharge valve may be closed during inhalation and open during exhalation.

The mask for preventing inhalation of pollutants may further include a support member installed inside the air pocket and configured to support an inner surface of the air pocket to change an inner volume of the air pocket during inhalation and exhalation.

The support member may be formed in a form of a tube of which one side end portion communicates with the breathing space and the other side end portion is coupled to the inner surface of the air pocket such that an air path separated from the inner space of the air pocket is formed inside the air pocket, wherein air inside the air path may be discharged to the breathing space to decrease a support force thereof and decrease the inner volume of the air pocket during inhalation, and the air inside the breathing space may be introduced into an inside of the air path to increase the support force thereof and increase the inner volume of the air pocket during exhalation.

The air pocket may be integrally formed with the inner surface of the mask main body or detachably coupled to the inner surface of the mask main body.

An adhesive contact member pressed against the user's face while being deformed according to a curve of the user's face may be formed on an edge portion of the mask main body.

The mask for preventing inhalation of pollutants may further include a wearing member formed on one or both sides of the mask main body such that the mask main body may be worn on the user's face or head.

The air pocket may be formed of a filter material which filters pollutants contained in air passing through the mask main body.

Another aspect of the present invention provides a mask for preventing inhalation of pollutants including a mask main body which covers a user's face and forms a breathing space which is a space formed between an inner surface thereof and the user's face, wherein a respiratory organ of the user performs breathing through the space, an air pocket formed on one side of the mask main body such that at least one part thereof is exposed to an outside of the mask, wherein an inside of the air pocket is filled with external air passing through a surface thereof exposed to the outside, and an air guide member operated to supply the air inside the air pocket to the breathing space during inhalation and discharge air inside the breathing space to the outside during exhalation.

### Advantageous Effects

According to the present invention, since a mask for preventing inhalation of pollutants according to the present invention additionally includes an air pocket formed at an inside of a breathing space which is a sealed space formed between the mask main body pressed against a user's face and the user's face or formed at an outer side of the mask main body and filled with purified air introduced from the outside through a mask main body or with external air, the purified air is supplied to the user during inhalation, air generated during exhalation is discharged to an outside of the mask, and thus there is an advantage in that inhalation of external pollutants can be prevented while breathing through a simple structure.

In addition, since a mask for preventing inhalation of pollutants according to the present invention can minimize mixing of intake air and discharge air inside the breathing space through such a structure as described above, there is an advantage in that breathing discomfort due to the mask being worn can be significantly reduced.

In addition, since a mask for preventing inhalation of pollutants according to the present invention uses a method in which a user inhales air which prefills an air pocket, there is an advantage in that breathing discomfort due to the mask being worn can be further reduced in comparison to a mask according to a conventional technology in which a mask main body directly covers a respiratory organ and external air is inhaled through air vents of the mask main body whenever breathing is performed.

### DESCRIPTION OF DRAWINGS

FIG. 1 is a view illustrating a wearing state of a mask for preventing inhalation of pollutants according to one embodiment of the present invention.

FIGS. 2A and 2B are cross-sectional views respectively taken along lines A-A and B-B in FIG. 1.

FIG. 3 is a view for describing an operational state of the mask for preventing inhalation of pollutants illustrated in FIG. 1.

FIGS. 4 to 9 are views illustrating modified examples of the mask for preventing inhalation of pollutants illustrated in FIG. 1.

### MODES OF THE INVENTION

Hereinafter, exemplary embodiments of the present invention will be described with reference to the accompanying drawings in detail.

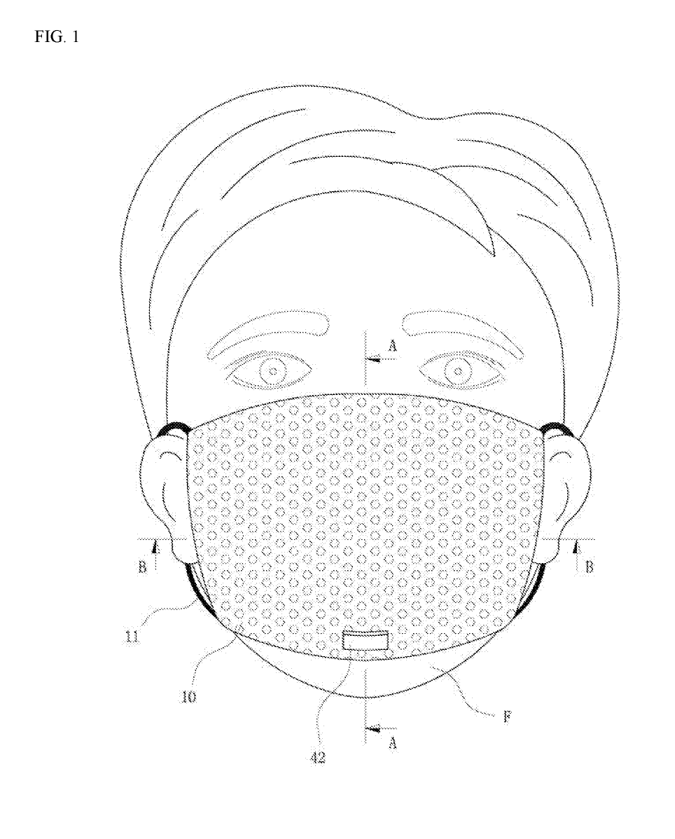

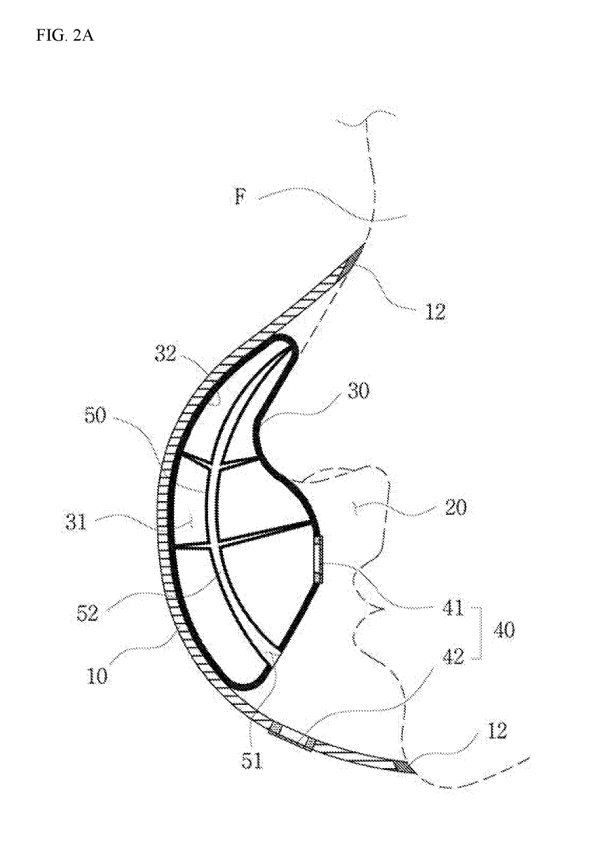

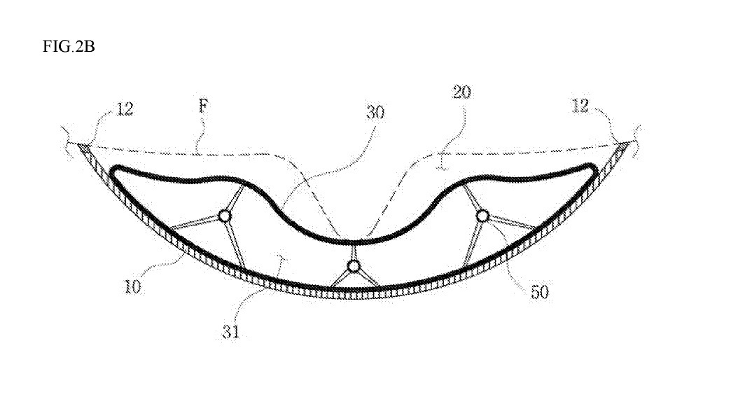

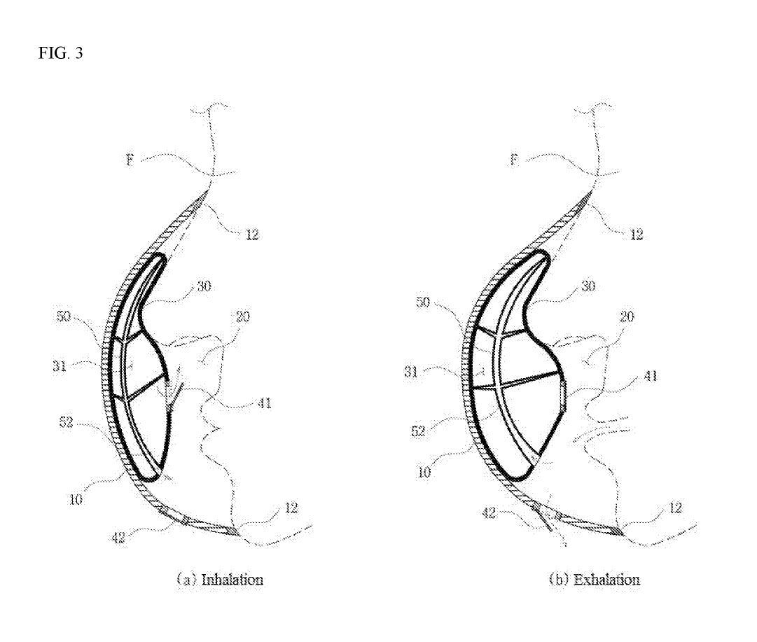

FIG. 1 is a view illustrating a wearing state of a mask for preventing inhalation of pollutants according to one embodiment of the present invention, FIGS. 2A and 2B are cross-sectional views respectively taken along lines A-A and B-B in FIG. 1, and FIG. 3 is a view for describing an operational state of the mask for preventing inhalation of pollutants illustrated in FIG. 1.

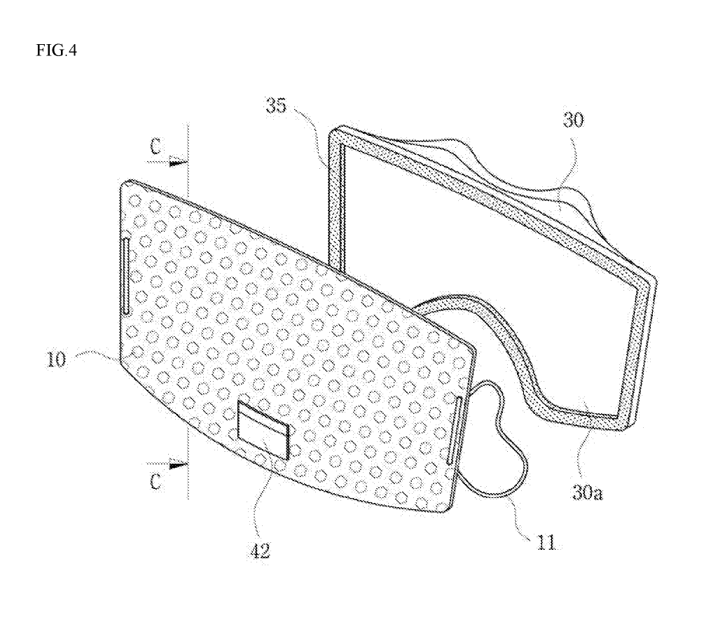

In addition, FIGS. 4 to 9 are views illustrating modified examples of the mask for preventing inhalation of pollutants illustrated in FIG. 1.

The mask for preventing inhalation of pollutants includes a mask main body 10 which covers a user's face F and in which a breathing space 20 is formed between an inner surface thereof and the user's face F, an air pocket 30 interposed between the mask main body 10 and the user's face F, and an air guide member 40 configured to operate such that air inside the air pocket 30 is supplied to the breathing space 20 during inhalation and air in the breathing space 20 is discharged to the outside during exhalation.

Here, the mask main body 10 serves as a first filter which prevents direct introduction of pollutants such as dust, yellow dust, fine dust, and the like contained in air into the user's respiratory organ similar to a conventional mask, and may be made of a cloth material such as cotton and a non-woven fabric having air permeability, a synthetic resin material such as silicone and polyester, or a porous material which may filter pollutants when external air is introduced thereto.

In addition, the mask main body 10 may also be formed of a shape memory material capable of maintaining a shape deformed according to a curve of the user's face F such that an edge portion of the mask main body 10 is easily pressed against the user's face F, as will be described below.

In addition, the mask main body 10 may further include wearing members 11 having a shape of a string, a rubber band, a pin, or the like at one or both sides thereof such that the mask main body 10 is easily worn on the user's face or head and is pressed against the user's face F.

In addition, the mask main body 10 may further include a contact member 12 at the edge portion thereof to press the mask main body 10 against the user's face F, and the breathing space 20 formed inside the mask main body 10 may be formed as a sealed space separated from the outside (that is an outside of the mask main body) through the above described structure.

In addition, the air pocket 30 is formed inside the mask main body 10, that is, formed at one side of the breathing space 20, and the inside of the air pocket 30 is filled with air passing through the mask main body 10.

Here, the air pocket 30 may be formed of a material different from that of the mask main body 10, as in the embodiment, but is not limited thereto, and may be integrally formed with the inner surface of the mask main body 10 according to necessity.

In addition, in a case in which the air pocket 30 is formed of a material different from that of the mask main body 10, the air pocket 30 may be simply formed to be interposed between the mask main body 10 and the user's face F, and may also be formed such that one surface 30a thereof is attached to the inner surface of the mask main body 10 to prevent unnecessary movement of the air pocket 30, as shown in FIG. 2A.

In addition, in a case in which the one surface 30a of the air pocket 30 is attached to the inner surface of the mask main body 10, the one surface 30a may be formed to be detachably coupled to the inner surface of the mask main body 10 to be replaceable, as shown in FIG. 4, according to necessity.

The detachable structure includes a detachable member 35 formed at an edge portion of the one surface 30a of the air pocket 30 and a detachable member (not shown) formed on the inner surface of the mask main body 10 and coupled to the detachable member 35 as one example of the embodiment, and the detachable member 35 may be preferably formed by using various known coupling structures using a conventional Velcro method, an insertion coupling method using a groove-protrusion structure, and the like.

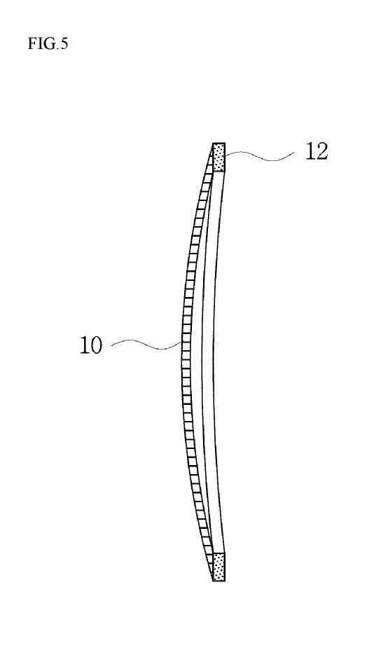

In addition, in the case in which the air pocket 30 is formed as the detachable structure as described, it is further preferable for the mask main body 10 to be formed of a washable material, and even in this case, it is preferable for the above described contact member 12 to be formed on the edge portion of the mask main body 10, as shown in FIG. 5 illustrating the cross-section taken along line C-C of FIG. 4.

In addition, it is further preferable for the air pocket 30 to be formed of a filter material (a filter paper, a non-woven fabric, cotton, a membrane having a mesh structure, or the like) capable of filtering the remaining pollutants contained in air passing through the mask main body 10, and the air pocket 30 serves to additionally filter pollutants contained in external air during a process in which the external air primarily filtered while passing through the mask main body 10 is introduced thereto through such a structure.

In addition, the air pocket 30 may have an outer surface having adhesion such that a portion in contact with the user's face F is adhered to the user's face F, and, through such a structure, in a case in which the user exercises while wearing the mask, unnecessary movement of the air pocket 30 is prevented, and even in a case in which hermeticity of the breathing space 20 due to the contact member 12 is not maintained, inhalation of external pollutants may be minimized.

Meanwhile, the air guide member 40 includes an inhalation valve 41 formed on one side of the air pocket 30 to guide air inside the air pocket 30 to the breathing space 20 or to block the air, and a discharge valve 42 formed on one side of the mask main body 10 to guide air inside the breathing space 20 to the outside of the mask or block the air.

The inhalation valve 41 is installed at the outer surface of the air pocket 30, is opened due to an inhalation force of a user's respiratory organ during inhalation, and is closed due to a pressure of air discharged from the user's respiratory organ and an elastic force thereof during exhalation as one example of the embodiment.

In addition, in the embodiment, the discharge valve 42 is installed at an outer surface of the mask main body 10, is closed due to the inhalation force of the user's respiratory organ and an elastic force thereof during inhalation, and is opened due to the pressure of air discharged from the user's respiratory organ during exhalation.

Here, it is preferable for the inhalation valve 41 and the discharge valve 42 to be formed of a material or to have a structure having a suitable elastic restoring force.

In addition, since the inhalation valve 41 is open during inhalation and is closed during exhalation to supply purified air in the air pocket 30 to the breathing space 20, inhalation of pollutants is prevented while the user breathes, and since the discharge valve 42 is closed during inhalation and is open during exhalation, mixing of air discharged during the exhalation and intake air in the breathing space 20 is minimized.

According to the above described structure, the mask for preventing inhalation of pollutants according to the present invention can prevent inhalation of external pollutants while breathing through a very simple structure, and mixing of intake air and discharge air in the breathing space 20 can be minimized, and thus breathing discomfort of a user due to the mask being worn can be significantly reduced.

Meanwhile, the mask for preventing inhalation of pollutants according to the embodiment may also further include a support member 50 installed inside the air pocket 30 so that purified air in an inner space 31 of the air pocket 30 may be more easily supplied to the breathing space 20 during inhalation, and an inside of the air pocket 30 may be more easily filled with air passing through the mask main body 10 from the outside of the mask to be supplied thereto during exhalation.

Here, the support member 50 supports an inner surface 32 of the air pocket 30 to change an inner volume of the air pocket 30 during inhalation and exhalation (specifically, to decrease the volume during inhalation and to increase the volume during exhalation).

To this end, the support member 50 according to the embodiment is formed in a form of a tube of which one side end portion 51 communicates with the breathing space 20 and the other side end portion is coupled to the inner surface 32 of the air pocket 30 such that an air path 52 separated from the inner space 31 of the air pocket 30 is formed inside the air pocket 30.

In this case, at least one end portion may form the open one side end portion 51, and at least one end portion may form the other side end portion connected to the one side end portion 51 through the same air path 52.

As one example of the embodiment, at least three other side end portions are coupled to the inner surface 32 of the air pocket 30 for one of the one side end portion 51, as shown in FIG. 2B.

In addition, the support member 50 formed in the above described structure decreases a volume of the inner space 31 of the air pocket 30 because air inside the air path 52 is discharged into the breathing space 20 to decrease a support force thereof during inhalation, and increases the volume of the inner space 31 of the air pocket 30 because air of the breathing space 20 (that is, air discharged from the user's respiratory organ during exhalation) is introduced into the air path 52 to increase the support force thereof during exhalation as shown in FIG. 3.

Here, only some of the air discharged from the user's respiratory organ during exhalation is introduced into the inside of the air path 52 to be used to increase the support force of the support member 50, and most of the remaining air is discharged to the outside of the mask main body 10 through the discharge valve 42.

In addition, in the case of the embodiment, the support member 50 is formed by using a corrugated tube having a volume thereof that easily changes due to air pressure such that the support force may easily increase or decrease due to air flow.

In addition, the case in which the support force of the support member 50 is changed by a pressure change of the inside of the breathing space 20 due to the user breathing is described as one example of the embodiment, but the support member 50 is not limited thereto, and various methods such as a method using a temperature change of the inside of the breathing space 20 within a range in which the same function is performed may be applied to the support member 50.

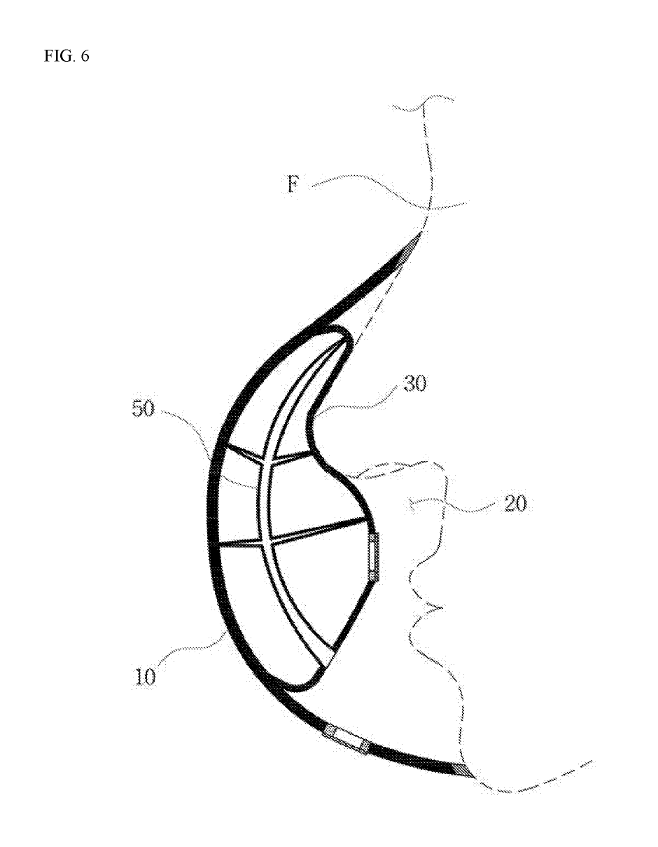

Meanwhile, the case in which the air pocket 30 is integrally formed with the inner surface of the mask main body 10 or separately formed from the mask main body 10 is described as one example of the embodiment, but the air pocket 30 is not limited thereto, and the air pocket 30 may be formed to include a portion which extends outward from an outer circumferential edge of the mask to cover the user's face F in the mask for preventing inhalation of pollutants according to the present invention, as shown in FIG. 6, according to necessity.

In this case, the mask main body 10 described throughout the specification and the claims of the present disclosure denotes a surface exposed to the outside among portions of the air pocket 30.

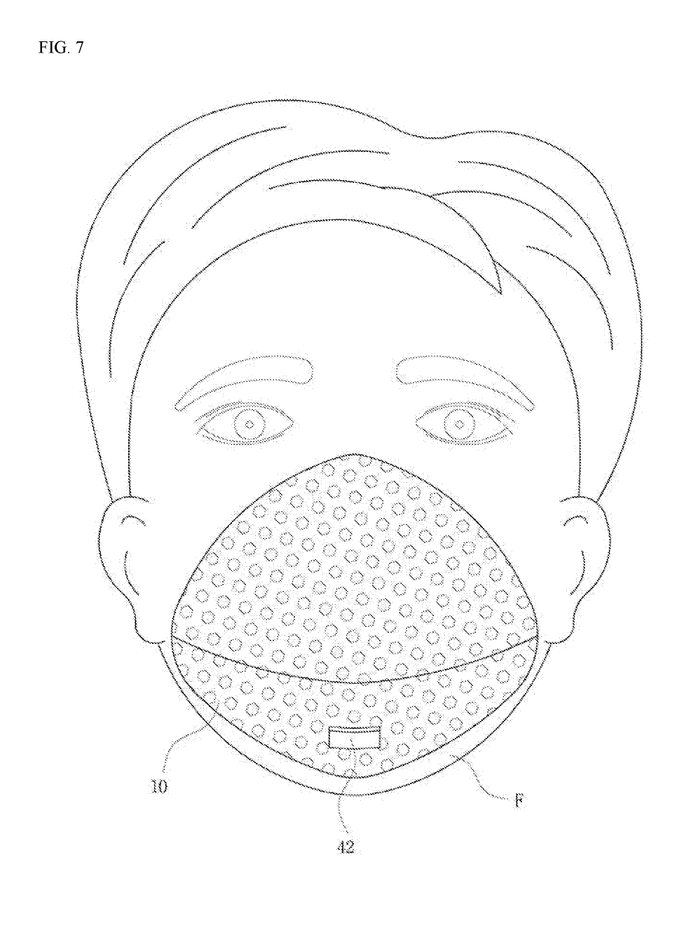

In addition, the case in which the mask main body 10 is worn on the user's face F or head by using the wearing member 11 is described as one example of the embodiment, but the mask main body 10 may be formed in a cap shape such that the mask main body 10 is directly worn on the user's face F without using the wearing member, as shown in FIG. 7, according to necessity.

In this case, it is further preferable for the contact member 12 formed on the edge portion of the above described mask main body 10 to be formed of a material having flexibility and adhesion such as a silicone material such that a shape thereof is changed according to a curve of the user's face F and tightly pressed against the user's face F to improve adhesion with the user's face F.

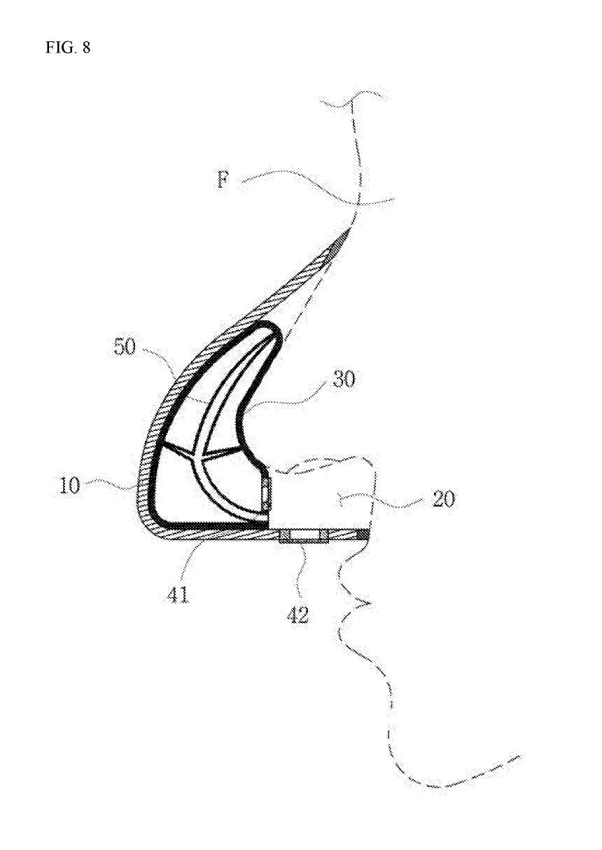

In addition, although the case in which the mask main body 10 covers the entire face is described as one example of the embodiment, the mask main body 10 may also be formed to cover only the user's nose to reduce a heavy or bulky feeling that the user feels when wearing the mask main body 10, as shown in FIG. 8, according to necessity.

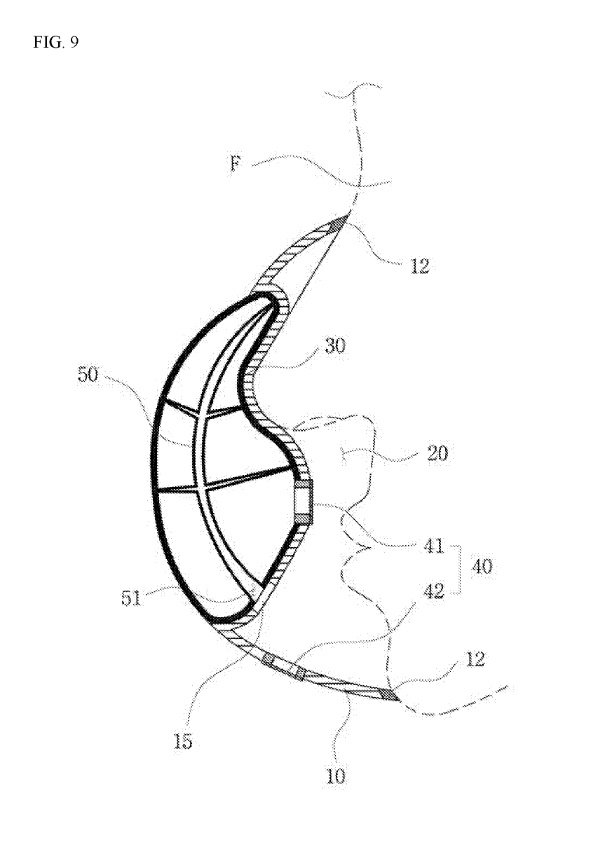

Meanwhile, the case in which the air pocket 30 is installed toward the inner surface of the mask main body 10 is described in all of the embodiments and modified examples of the present invention, but the air pocket 30 may be formed toward one side (specifically, toward the outer surface) of the mask main body 10 such that at least one part of the air pocket 30 is exposed to the outside of the mask, as shown in FIG. 9, within a range in which the air pocket 30 performs the same function.

In this case, external air is introduced into the air pocket 30 though a surface of the air pocket 30 exposed to the outside of the mask, and since the air pocket 30 is formed of a filter material, pollutants contained in the external air are filtered during the above process.

However, in a case in which the air pocket 30 is formed as shown in FIG. 9, the inhalation valve 41 may be installed on one side of the air pocket 30 or one side of the mask main body 10, and, in the former case, through holes (not shown) for exposing the inhalation valve 41 to the inside of the breathing space 20 should be formed in the mask main body 10, or, in the latter case, through holes (not shown) should be formed in the air pocket 30, and thus the inside of the air pocket 30 communicates with the breathing space 20 when the inhalation valve 41 is open.

In addition, in the case in which the air pocket 30 is formed as shown in FIG. 9, the open one side end portion 51 of the support member 50 is formed to communicate with the breathing space 20 through a through hole 15 formed in the mask main body 10.

### INDUSTRIAL APPLICABILITY

The present invention relates to a mask for preventing inhalation of pollutants which additionally includes an air pocket formed on an outer or inner side of the mask and filled with external air to prevent inhalation of external pollutants while breathing, minimize breathing discomfort, and thus to supply a more effective means for preventing inhalation of pollutants to a user, particularly, to a patient with a respiratory condition, in a situation in which air pollution due to yellow dust is serious and to maximize the user's convenience.

Accordingly, since the present invention can be a more effective respiratory assistant device in the case in which the present invention is used by a patient with a respiratory condition in a medical institution such as a hospital as well as by general users, the present invention can be used as a household health care product or a supplemental medical product

1. A mask for preventing inhalation of pollutants, comprising:
a mask main body which covers a user's face and forms a breathing space which is a space formed between an inner surface thereof and the user's face, wherein a respiratory organ of the user performs breathing through the space;
an air pocket formed on one side of the breathing space and filled with air passing through the mask main body from an outside of the mask; and
an air guide member operated to supply the air inside the air pocket to the breathing space during inhalation and discharge air inside the breathing space to the outside during exhalation.

2. The mask for preventing inhalation of pollutants of claim 1, wherein the air guide member includes:
an inhalation valve installed on one side of the air pocket to guide the air inside the air pocket to the breathing space or block the air; and
a discharge valve installed on one side of the mask main body to guide the air inside the breathing space to the outside or block the air,
wherein:
the inhalation valve is open during inhalation and is closed during exhalation; and
the discharge valve is closed during inhalation and is open during exhalation.

3. The mask for preventing inhalation of pollutants of claim 1, further comprising a support member installed inside the air pocket and configured to support an inner surface of the air pocket to change an inner volume of the air pocket during inhalation and exhalation.

4. The mask for preventing inhalation of pollutants of claim 3, wherein the support member is formed in a form of a tube of which one side end portion communicates with the breathing space and the other side end portion is coupled to the inner surface of the air pocket such that an air path separated from the inner space of the air pocket is formed inside the air pocket,
wherein:
air inside the air path is discharged to the breathing space to decrease a support force thereof and decrease the inner volume of the air pocket during inhalation; and
the air inside the breathing space is introduced into an inside of the air path to increase the support force thereof and increase the inner volume of the air pocket during exhalation.

5. The mask for preventing inhalation of pollutants of claim 1, wherein the air pocket is integrally formed with the inner surface of the mask main body or detachably coupled to the inner surface of the mask main body.

6. The mask for preventing inhalation of pollutants of claim 1, wherein an adhesive contact member pressed against the user's face while being deformed according to a curve of the user's face is formed on an edge portion of the mask main body.

7. The mask for preventing inhalation of pollutants of claim 1, further comprising a wearing member formed on one or both sides of the mask main body such that the mask main body is worn on the user's face or head.

8. The mask for preventing inhalation of pollutants of claim 1, wherein the air pocket is formed of a filter material which filters pollutants contained in air passing through the mask main body.

9. A mask for preventing inhalation of pollutants, comprising:
a mask main body which covers a user's face and forms a breathing space which is a space formed between an inner surface thereof and the user's face, wherein a respiratory organ of the user performs breathing through the space;
an air pocket formed on one side of the mask main body such that at least one part thereof is exposed to an outside of the mask, wherein an inside of the air pocket is filled with external air passing through a surface thereof exposed to the outside; and
an air guide member operated to supply the air inside the air pocket to the breathing space during inhalation and discharge air inside the breathing space to the outside during exhalation.

10. The mask for preventing inhalation of pollutants of claim 9, wherein the air guide member includes:
an inhalation valve installed on one side of the air pocket or the mask main body to guide the air inside the air pocket to the breathing space or block the air; and
a discharge valve installed on one side of the mask main body to guide the air inside the breathing space to the outside or block the air,
wherein:
the inhalation valve is open during inhalation and is closed during exhalation; and
the discharge valve is closed during inhalation and is open during exhalation.

11. The mask for preventing pollutant inhalation of claim 9, further comprising a support member installed inside the air pocket and configured to support an inner surface of the air pocket to change an inner volume of the air pocket during inhalation and exhalation.

12. The mask for preventing inhalation of pollutants of claim 11, wherein the support member is formed in a form of a tube of which one side end portion communicates with the breathing space and the other side end portion is coupled to the inner surface of the air pocket such that an air path separated from the inner space of the air pocket is formed inside the air pocket,
wherein:
air inside the air path is discharged to the breathing space to decrease a support force thereof and decrease the inner volume of the air pocket during inhalation; and
the air inside the breathing space is introduced into an inside of the air path to increase the support force thereof and increase the inner volume of the air pocket during exhalation.

13. The mask for preventing inhalation of pollutants of claim 2, wherein the air pocket is integrally formed with the inner surface of the mask main body or detachably coupled to the inner surface of the mask main body.

14. The mask for preventing inhalation of pollutants of claim 3, wherein the air pocket is integrally formed with the inner surface of the mask main body or detachably coupled to the inner surface of the mask main body.

15. The mask for preventing inhalation of pollutants of claim 4, wherein the air pocket is integrally formed with the inner surface of the mask main body or detachably coupled to the inner surface of the mask main body.

16. The mask for preventing inhalation of pollutants of claim 2, wherein an adhesive contact member pressed against the user's face while being deformed according to a curve of the user's face is formed on an edge portion of the mask main body.

17. The mask for preventing inhalation of pollutants of claim 3, wherein an adhesive contact member pressed against the user's face while being deformed according to a curve of the user's face is formed on an edge portion of the mask main body.

18. The mask for preventing inhalation of pollutants of claim 4, wherein an adhesive contact member pressed against the user's face while being deformed according to a curve of the user's face is formed on an edge portion of the mask main body.

19. The mask for preventing inhalation of pollutants of claim 2, further comprising a wearing member formed on one or both sides of the mask main body such that the mask main body is worn on the user's face or head.

20. The mask for preventing inhalation of pollutants of claim 2, wherein the air pocket is formed of a filter material which filters pollutants contained in air passing through the mask main body.
